(19) United States
(12) Patent Application Publication
(10) Pub. No.: US 2025/0037050 A1
(43) Pub. Date: Jan. 30, 2025

(54) AUTOMATED GENERATION OF ROTATION SCHEDULES

(71) Applicant: Dell Products L.P., Round Rock, TX (US)

(72) Inventors: Ginamarie E. Spiridigliozzi, Cumberland, RI (US); William S. Burney, Apex, NC (US); Raghav Chitta Nagaraj, Holly Springs, NC (US)

(21) Appl. No.: 18/357,388

(22) Filed: Jul. 24, 2023

(51) Int. Cl. G06Q 10/0631

(52) U.S. Cl. CPC G06Q 10/06314; G06Q 10/06311; G06Q 10/06312

(57) ABSTRACT

An apparatus comprises a processing device configured to receive a request to generate a given instance of a rotation schedule and to establish one or more data feeds each comprising information affecting eligibility of assets for inclusion in the given instance of the rotation schedule. The processing device is also configured to generate one or more data structures by parsing information from the data feeds, the data structures comprising a filtered subset of the assets which are eligible to be selected for inclusion in the given instance of the rotation schedule. The processing device is further configured to generate the given instance of the rotation schedule by selecting, from among the filtered subset, one or more of the assets for the given instance of the rotation schedule based on information from the data feeds characterizing requirements related to composition of the given instance of the rotation schedule.

### BACKGROUND

An organization which manages a large number of assets, such as information technology (IT) assets including physical and virtual computing resources, may break such assets up into a number of groups. Members of the organization which are responsible for managing such IT assets may also be broken up into groups. For example, the organization may include assets or members in different geographic regions, with different capabilities and functionality, etc. In some cases, the organization seeks to operate a subset of its assets or members in accordance with a rotation schedule, where the assets in the rotation schedule are rotated in and out over time. For large organizations with many assets or members, generating such rotation schedules is a difficult and time-consuming task.

### SUMMARY

Illustrative embodiments of the present disclosure provide techniques for automated generation of rotation schedules.

In one embodiment, an apparatus comprises at least one processing device comprising a processor coupled to a memory. The at least one processing device is configured to receive a request to generate a given instance of a rotation schedule and to establish one or more data feeds, each of the one or more data feeds comprising information affecting eligibility of a plurality of assets for inclusion in the given instance of the rotation schedule. The at least one processing device is also configured to generate one or more data structures by parsing information from the one or more data feeds, the one or more data structures comprising a filtered subset of the plurality of assets which are eligible to be selected for inclusion in the given instance of the rotation schedule. The at least one processing device is further configured to generate the given instance of the rotation schedule by selecting. from among the filtered subset of the plurality of assets which are eligible to be selected for inclusion in the given instance of the rotation schedule, one or more of the plurality of assets for the given instance of the rotation schedule, wherein selecting the one or more of the plurality of assets for the given instance of the rotation schedule is based at least in part on information from at least one of the one or more data feeds characterizing requirements related to composition of the one or more assets in the given instance of the rotation schedule.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for automated generation of rotation schedules in an illustrative embodiment.

FIG. 2 is a flow diagram of an exemplary process for automated generation of rotation schedules in an illustrative embodiment.

FIG. 3 shows a system flow for automated generation of rotation schedules in an illustrative embodiment.

FIG. 4 shows a graphical user interface for a rotation auto-scheduler tool in an illustrative embodiment.

FIG. 5 shows a system flow for applying feedback to generated rotation schedules in an illustrative embodiment.

FIG. 6 shows a system for implementing rotation scheduling logic of a rotation auto-scheduler tool to generate rotation schedules in an illustrative embodiment.

FIG. 7 shows a process flow for manual generation of rotation schedules in an illustrative embodiment.

FIG. 8 shows a process flow for automated generation of rotation schedules using a rotation auto-scheduler tool in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

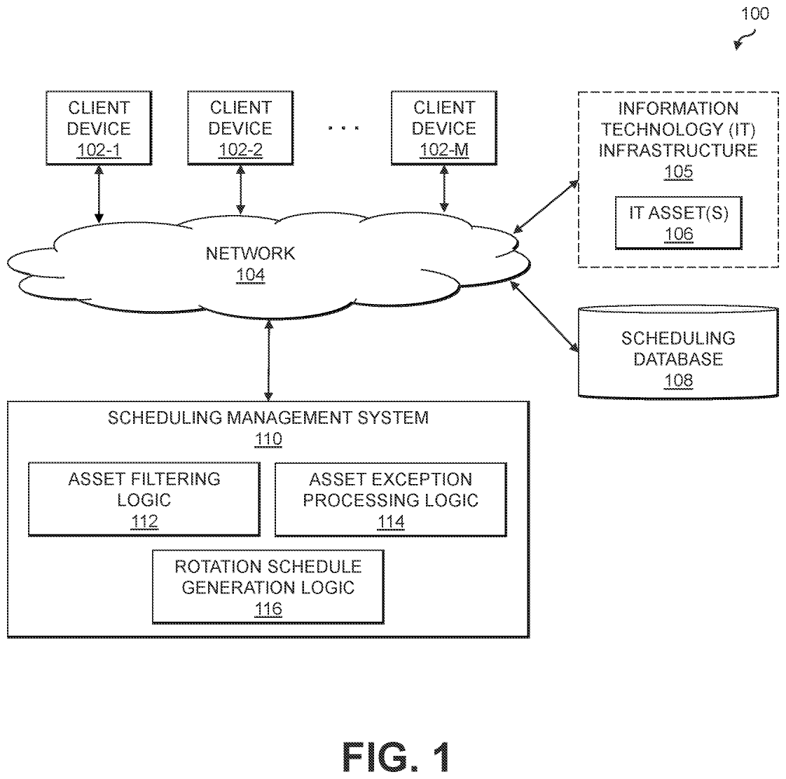

FIG. 1 shows an information processing system 100 configured in accordance with an illustrative embodiment. The information processing system 100 is assumed to be built on at least one processing platform and provides functionality for automated generation of rotation schedules. A rotation schedule is a schedule that is utilized for some designated period of time (e.g., one or more hours, days, weeks, etc.), where in each instance of the rotation schedule a subset of a plurality of assets is selected for inclusion in that instance of the rotation schedule. The information processing system 100 includes a set of client devices 102-1, 102-2 . . . 102-M (collectively, client devices 102) which are coupled to a network 104. Also coupled to the network 104 is an information technology (IT) infrastructure 105 comprising one or more IT assets 106, a scheduling database 108, and a scheduling management system 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc. In some embodiments, the IT assets 106 may include robots or automated factory equipment, artificial intelligence (AI)-driven software bots, etc., which are used for performing various tasks for which it is desired that the IT assets 106 selected for such tasks operate in accordance with a rotation schedule.

The IT assets 106 of the IT infrastructure 105 may host applications that are utilized by respective ones of the client devices 102, such as in accordance with a client-server computer program architecture. In some embodiments, the applications comprise web applications designed for delivery from assets in the IT infrastructure 105 to users (e.g., of client devices 102) over the network 104. Various other examples are possible, such as where one or more applications are used internal to the IT infrastructure 105 and not exposed to the client devices 102. The client devices 102 and/or IT assets 106 of the IT infrastructure 105 may utilize one or more machine learning algorithms as part of such applications. As described in further detail below, the scheduling management system 110 can advantageously be used to determine an optimal or improved rotation schedule for assets of an entity which are selected for performing one or more desired tasks. This may include, by way of example, selecting IT assets 106 of the IT infrastructure 105 which are used to perform a desired task. This may also or alternatively include selecting members of an entity (e.g., users of the client devices 102) which are responsible for managing the IT assets 106 of the IT infrastructure 105 or performing various other desired tasks (e.g., providing coverage across geographic regions, time zones, domain expertise, etc.).

In some embodiments, the scheduling management system 110 is used for an enterprise system. For example, an enterprise may subscribe to or otherwise utilize the scheduling management system 110 for generating rotation schedules responsible for various tasks such as management of the IT assets 106 of the IT infrastructure 105. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The scheduling database 108 is configured to store and record various information which is used by the scheduling management system 110 in order to generate rotation schedules. Such information may include, for example, information regarding requirements for rotation schedules (e.g., numbers of assets to be included in each rotation schedule, the required skill sets or functionalities for the assets selected for inclusion in each rotation schedule, etc.). Such information may also include lists of assets which are eligible for selection or inclusion in the rotation schedules, exception lists, etc. The exception lists may take the form of automated feeds of information which are set up as representation state transfer (REST) or other application programming interfaces (APIs) which the scheduling management system 110 may access to apply the exception lists when generating different instances of the rotation schedule. In some embodiments, one or more of the storage systems utilized to implement the scheduling database 108 comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the scheduling management system 110, as well as to support communication between the scheduling management system 110 and other related systems and devices not explicitly shown.

The client devices 102 are configured to access or otherwise utilize the IT infrastructure 105. In some embodiments, the client devices 102 are assumed to be associated with system administrators, IT managers or other authorized personnel responsible for managing the IT assets 106 of the IT infrastructure 105 (e.g., where such management includes providing technical or customer support for the IT assets 106). For example, a given one of the client devices 102 may be operated by a user to access a graphical user interface (GUI) provided by the scheduling management system 110 to manage a rotation schedule for assets of an organization (e.g., the IT assets 106 of the IT infrastructure 105, team members of the organization which are responsible for managing one or more of the IT assets 106 of the IT infrastructure 105) for different periods of time. The scheduling management system 110 may be provided as a cloud service that is accessible by the given client device 102 to allow the user thereof to manage rotation schedules, which includes approving generated instances of the rotation schedule, submitting change requests for generated instances of the rotation schedule, etc.

In some embodiments, the rotation schedule may operate on a relatively large time scale (e.g., such as where each instance of the rotation schedule lasts for a week or more), and it is desired to equitably select assets for inclusion in each instance of the rotation schedule so as not to disrupt other work that the selected assets are responsible for. Where the assets are team members of an organization, for example, it may be desired to select the team members for inclusion in the rotation schedule such that the same team members are not selected for inclusion in more than one instance of the rotation schedule until all or some designated threshold of other eligible team members have been selected for inclusion in an instance of the rotation schedule. In other embodiments, the rotation schedule may operate on a relatively short time scale (e.g., 24 hours, in order to provide around-the-clock support coverage). Even for the relatively short time scale, it is still desired to equitably select assets for inclusion in each instance of the rotation schedule. Where the assets are team members of an organization, for example, it may be desired to select the team members for inclusion in the rotation schedule such that any given team member would not be required to work multiple 24-hour shifts before others have not worked a single one, or so that any given team member is not selected for multiple overnight portions of the 24-hour shift before others have not worked at least one overnight portion of the 24-hour shift, etc.

The IT assets 106 of the IT infrastructure 105 may be owned or operated by the same enterprise that operates the scheduling management system 110 (e.g., where an enterprise such as a business provides support for the assets it operates). In other embodiments, the IT assets 106 of the IT infrastructure 105 may be owned or operated by one or more enterprises different than the enterprise which operates the scheduling management system 110 (e.g., a first enterprise provides support for assets that are owned by multiple different customers, business, etc.). Various other examples are possible.

In some embodiments, the client devices 102 and/or the IT assets 106 of the IT infrastructure 105 may implement host agents that are configured for automated transmission of information regarding rotation schedules (e.g., published rotation schedules from the scheduling management system 110, approvals or change requests for published rotation schedules which are provided to the scheduling management system 110, etc.). It should be noted that a “host agent” as this term is generally used herein may comprise an automated entity, such as a software entity running on a processing device. Accordingly, a host agent need not be a human entity.

The scheduling management system 110 in the FIG. 1 embodiment is assumed to be implemented using at least one processing device. Each such processing device generally comprises at least one processor and an associated memory, and implements one or more functional modules or logic for controlling certain features of the scheduling management system 110. In the FIG. 1 embodiment, the scheduling management system 110 implements asset filtering logic 112, asset exception processing logic 114, and rotation schedule generation logic 116. The scheduling management system 110 is configured to receive a request (e.g., from one of the client devices 102) to generate a given instance of a rotation schedule. The asset filtering logic 112 is then configured to obtain, from the scheduling database 108, a list of assets which are eligible for inclusion in the rotation schedule. This list of assets may include, for example, all assets of an organization that are responsible for performing a given task. The asset filtering logic 112 then applies various filters (e.g., which may be established via REST or other APIs between the scheduling management system 110 and the scheduling database 108 or another entity) to filter the full list of assets according to various influencing factors (e.g., geographic holidays, vacations, criticality of other work being performed by the assets, information related to assets selected for inclusion in previous iterations of the rotation schedule, etc.).

This filtered list of assets is then used by the rotation schedule generation logic 116 to select a subset of the assets in the filtered list for inclusion in the given instance of the rotation schedule. This selection may be random (e.g., from among the eligible assets in the filtered list) according to specified rotation requirements (e.g., numbers of assets, required skill sets or functionality, etc.). The given instance of the rotation schedule may then be published or otherwise communicated back to the client device 102 submitting the request to create the given instance of the rotation schedule (or to other interested parties), who may approve or submit change requests.

If any change requests are submitted, the asset exception processing logic 114 will analyze such change requests in order to update the list of assets who are eligible for inclusion in the generated instance of the rotation schedule. This may include adding or removing individual assets from the list, or creating one or more additional feeds with additional exclusion or filtering criteria. The asset filtering logic 112 is then re-applied using the updated list of assets and/or the additional feeds. The rotation schedule generation logic 116 will then re-select assets for the given instance of the rotation schedule. Such processing may be repeated as necessary, until the given instance of the rotation schedule has been accepted.

It is to be appreciated that the particular arrangement of the client devices 102, the IT infrastructure 105 and the scheduling management system 110 illustrated in the FIG. 1 embodiment is presented by way of example only, and alternative arrangements can be used in other embodiments. As discussed above, for example, the scheduling management system 110 (or portions of components thereof, such as one or more of the asset filtering logic 112, the asset exception processing logic 114, and the rotation schedule generation logic 116) may in some embodiments be implemented internal to one or more of the client devices 102 and/or the IT infrastructure 105.

At least portions of the asset filtering logic 112, the asset exception processing logic 114, and the rotation schedule generation logic 116 may be implemented at least in part in the form of software that is stored in memory and executed by a processor.

The scheduling management system 110 and other portions of the information processing system 100, as will be described in further detail below, may be part of cloud infrastructure.

The scheduling management system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the scheduling database 108 and the scheduling management system 110 or components thereof (e.g., the asset filtering logic 112, the asset exception processing logic 114, and the rotation schedule generation logic 116) may be implemented on respective distinct processing platforms, although numerous other arrangements are possible. For example, in some embodiments at least portions of the scheduling management system 110 and one or more of the client devices 102, the IT infrastructure 105 and/or the scheduling database 108 are implemented on the same processing platform. A given client device (e.g., 102-1) can therefore be implemented at least in part within at least one processing platform that implements at least a portion of the scheduling management system 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the scheduling database 108 and the scheduling management system 110, or portions or components thereof, to reside in different data centers. Numerous other distributed implementations are possible. The scheduling management system 110 can also be implemented in a distributed manner across multiple data centers.

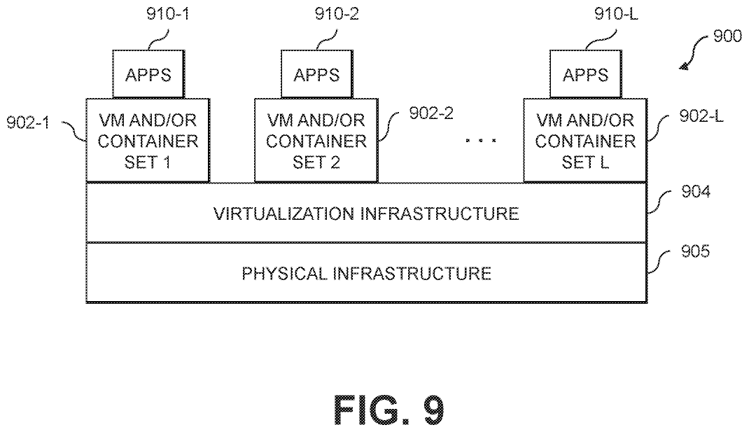

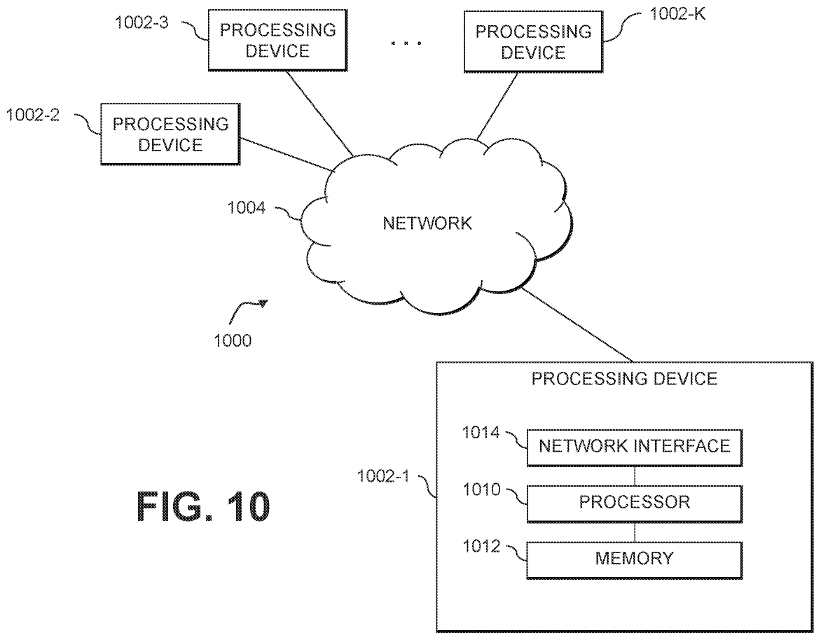

Additional examples of processing platforms utilized to implement the scheduling management system 110 and other components of the information processing system 100 in illustrative embodiments will be described in more detail below in conjunction with FIGS. 9 and 10.

It is to be understood that the particular set of elements shown in FIG. 1 for automated generation of rotation schedules is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

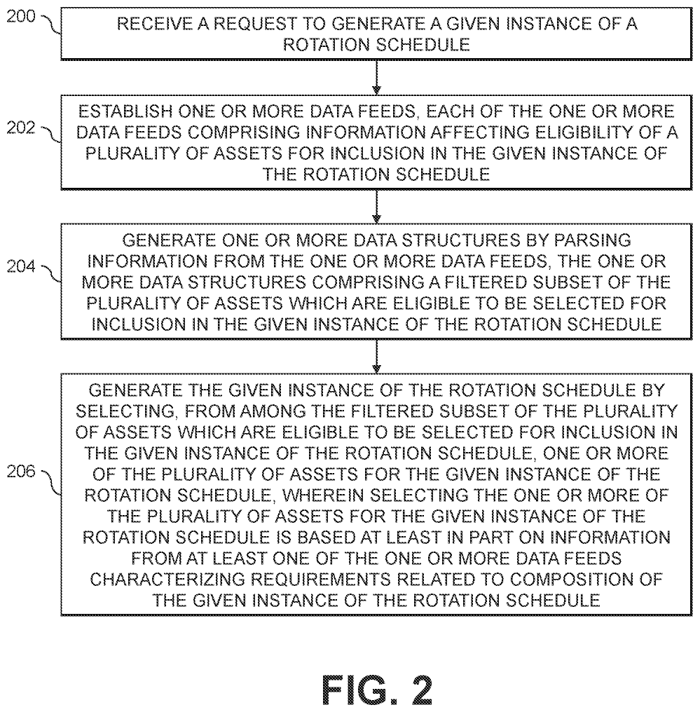

An exemplary process for automated generation of rotation schedules will now be described in more detail with reference to the flow diagram of FIG. 2. It is to be understood that this particular process is only an example, and that additional or alternative processes for automated generation of rotation schedules may be used in other embodiments.

In this embodiment, the process includes steps 200 through 206. These steps are assumed to be performed by the scheduling management system 110 utilizing the asset filtering logic 112. the asset exception processing logic 114, and the rotation schedule generation logic 116. The process begins with step 200, receiving a request to generate a given instance of a rotation schedule. In step 202, one or more data feeds are established. Each of the one or more data feeds comprises information affecting eligibility of a plurality of assets for inclusion in the given instance of the rotation schedule. The one or more data feeds may comprise one or more REST APIs. At least one of the one or more REST APIs may be established with a scheduling database maintained by an organization managing the plurality of assets. The plurality of assets may comprise IT assets of an IT infrastructure. The rotation schedule may specify a given team of an organization that is responsible for management of one or more IT assets of the organization.

In step 204, one or more data structures are generated by parsing information from the one or more data feeds. The one or more data structures may comprise a filtered subset of the plurality of assets which are eligible to be selected for inclusion in the given instance of the rotation schedule. The given instance of the rotation schedule is generated in step 206 by selecting, from among the filtered subset of the plurality of assets which are eligible to be selected for inclusion in the given instance of the rotation schedule, one or more of the plurality of assets for the given instance of the rotation schedule. Selecting the one or more of the plurality of assets for the given instance of the rotation schedule is based at least in part on information from at least one of the one or more data feeds characterizing requirements related to composition of the given instance of the rotation schedule.

Step 204, in some embodiments, comprises: generating a first data structure by parsing first information from a first one of the one or more data feeds, the first information characterizing ones of the plurality of assets which may be selected for inclusion in the given instance of the rotation schedule; generating a second data structure by filtering the first data structure using second information parsed from a second one of the one or more data feeds, the second information characterizing scheduling conflicts for the ones of the plurality of assets which may be selected for inclusion in the given instance of the rotation schedule; generating a third data structure by filtering the second data structure using third information parsed from a third one of the one or more data feeds, the third information characterizing ones of the plurality of assets selected for inclusion in one or more previous instances of the rotation schedule; and generating a fourth data structure by selecting, using fourth information parsed from a fourth one of the one or more data feeds, the filtered subset of the plurality of assets which are eligible for inclusion in the given instance of the rotation schedule, the fourth information comprising one or more organization requirements related to composition of the given instance of the rotation schedule. Generating the first data structure may comprise creating a list of the plurality of assets meeting one or more eligibility criteria. Generating the second data structure may comprise utilizing the second information to at least one of: remove ones of the plurality of assets located in geographic regions having geographic holidays observed during a time frame of the given instance of the rotation schedule; and remove ones of the plurality of assets based at least in part on deadlines for one or more tasks that the plurality of assets are responsible for. Generating the third data structure may comprise utilizing the third information to remove ones of the plurality of assets which have been selected for inclusion in the one or more previous instances of the rotation schedule.

The requirements related to the composition of the assets in the given instance of the rotation schedule comprise one or more requirements related to at least one of: a number of the plurality of assets to be selected for inclusion in the given instance of the rotation schedule; geographic locations of ones of the plurality of assets to be selected for inclusion in the given instance of the rotation schedule; and functionalities of ones of the plurality of assets to be selected for inclusion in the given instance of the rotation schedule.

The FIG. 2 process may further comprise publishing the given instance of the rotation schedule and determining whether the given instance of the rotation schedule is accepted by one or more authorized users. Responsive to the one or more authorized users of the organization accepting the given instance of the rotation schedule, information in at least one of the one or more data feeds characterizing ones of the plurality of assets which have been selected for inclusion in the one or more previous instances of the rotation schedule is updated. Responsive to the one or more authorized users of the organization submitting one or more change requests for the given instance of the rotation schedule, information in at least one of the one or more data feeds characterizing at least one of ones of the plurality of assets which may be selected for inclusion in the given instance of the rotation schedule and scheduling conflicts for the ones of the plurality of assets which may be selected for inclusion in the given instance of the rotation schedule is updated. The given instance of the rotation schedule is then re-generated based at least in part on the modified information in said at least one of the one or more data feeds.

In some embodiments, generating and/or publishing the rotation schedule may be part of or include various automation functionality. For example, generating and/or publishing the rotation schedule may automatically deploy the given instance of the rotation schedule (e.g., at a start time of the given instance of the rotation schedule). This may include implementing the rotation schedule on the various assets which are selected for inclusion in the given instance of the rotation schedule at the appropriate time. When the assets selected for inclusion include, for example, physical and/or virtual computing resources, implementing the rotation schedule may include automatically activating or operating such physical and/or virtual computing resources at the beginning of the given instance of the rotation schedule. This may include, but is not limited to: powering on and/or instantiating the physical and/or virtual computing resources; loading the physical and/or virtual computing resources with one or more resources (e.g., software, data, etc.) that are used as part of performing one or more tasks of the given instance of the rotation schedule; configuring the physical and/or virtual computing resources to perform the one or more tasks of the given instance of the rotation schedule; etc. When the assets selected for inclusion include, for example, members of an organization, implementing the rotation schedule may include, but is not limited to: updating calendar applications on one or more client devices associated with the members of the organization; pre-loading client devices associated with those members to include one or more resources (e.g., software, data, etc.) that are used as part of performing one or more tasks of the given instance of the rotation schedule; etc. Various other automated actions may be taken in response to generating and/or publishing the given instance of the rotation schedule.

As discussed above, an organization with a large number of assets may break such assets up into a number of groups. In the description below, various use cases are described wherein the assets of an organization comprise employees or other members of the organization. It should be appreciated, however, that the assets may instead comprise IT assets (e.g., physical and/or virtual computing resources, including but not limited to robots or automated factory equipment, AI-driven software bots, etc., which are used for performing various tasks for which it is desired that the IT assets selected for such tasks operate in accordance with a rotation schedule). Employees or other members of an organization may be broken up into a number of member teams by functional and/or geographical constraints. In some cases, however, the organization may need to staff a central team with individuals across multiple member teams in the organization. The central team may be necessitated by an effort that should be shared across all the member teams. Due to the nature of the organization, the central team can sometimes disproportionately impact a small subset of the member teams. It is difficult, however, to ensure that service on this central team is rotated across all of the member teams of the organization such that the effort is shared by all the member teams equitably. Planning participation on the central team can be extremely complicated, if it appropriately takes into account the impact on different member teams, vacations, holidays and other factors.

As discussed above, an organization (e.g., a company, business, enterprise or other entity) may desire to create a central team that takes an initial look at support issues that are created for the organization. All of the member teams may take advantage of centralized infrastructure of the organization, including the work of the central team, to reduce the overall effort for individual member teams to do their work. In some situations, an infrastructure member team may get burdened by looking at all support issues before they are assigned to the correct member team that needs to look at the issue. This may lead to the infrastructure member team being overwhelmed by support issues, and thus unable to do any future looking work. Thus, the organization may decide to create a central team to take an initial look at these issues, with the central team being staffed from all or across multiple member teams in the organization.

One approach for setting up the central team relies on manual human effort (e.g., a single person) maintaining a spreadsheet and manually selecting the users that make up each rotation of the central team. Such an approach, however, is fraught with issues, including but not limited to: making sure that member teams are impacted proportionately; making sure that individual users don't serve on the central team before other users have served at all; determining impacts of user vacations on scheduling; determining impacts of different geographical holiday schedules on scheduling; identifying other higher priority work from within individual member teams which cause scheduling changes or conflicts; etc. Further, any scheduling change or conflict for the central team creates more issues, such as when new users are tapped to take earlier slots in the rotation schedule who also have conflicts. Thus, the rotation schedule for a central team of a large organization is too complex and not practical to manage manually by a human user.

Illustrative embodiments provide technical solutions which identify and parse feeds of data that can be used for automating the decisions which impact which assets are eligible to be part of a particular instance or iteration of a rotation schedule (e.g., which users can be part of a specific rotation of a central team). The technical solutions may process a full list of assets, using each feed as a filter to reduce the full list down to a filtered list of assets that are eligible for a given instance of the rotation schedule. The technical solutions can thus randomly select from the filtered list of assets to determine which assets will make up a given instance or iteration of the rotation schedule. The chosen list is then passed back through the feed logic, so that the feeds can make note of which assets were selected for each instance or iteration of the rotation schedule. Exceptions to a published schedule may be processed in a similar manner. Removal of assets based on exception flow handling (e.g., change requests from authorized users) are also sent to each feed so they can make note of such removals, and then the full list of assets can be processed again to choose replacements for the removed assets.

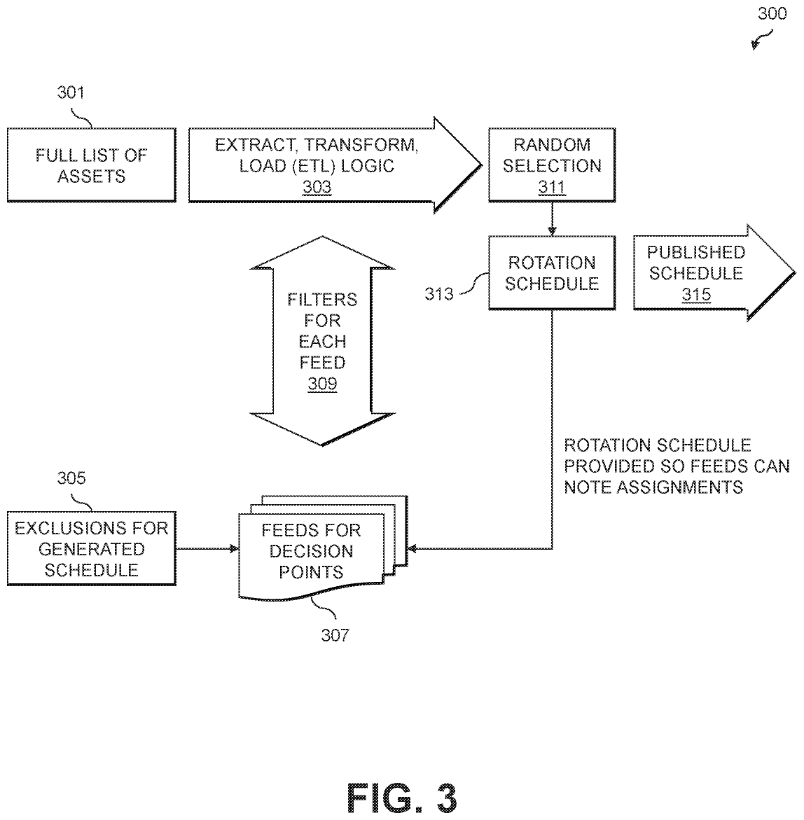

FIG. 3 shows a system 300 for generating an instance of a rotation schedule, in which a full list of assets 301 is provided to the Extract, Transform, Load (ETL) logic 303. Exclusions 305 for a generated instance of the rotation schedule are provided to various data feeds 307 for decision points. Filters 309 for each of the data feeds 307 are then applied and the result is input to the ETL logic 303. A random selection 311 is then performed based on the filtered list of assets produced by the ETL logic 303, to generate an instance of the rotation schedule 313, which may be output as a published schedule 315. The rotation schedule 313 may be provided as feedback to the data feeds 307, such that the data feeds 307 in future instances of generation of the rotation schedule 313 will take into account which assets were assigned in previous instances of the rotation schedule 313. Although not shown, feedback related to the generated instance of the rotation schedule 313 (e.g., change requests submitted by managers or other authorized users) may also be provided to the data feeds 307, with the filters 309 again being applied after which the ETL logic 303 produces an updated instance of the rotation schedule 313. The updated instance of the rotation schedule 313 may then be output as the published schedule 315.

The technical solutions described herein provide a rotation auto-scheduler tool, which may be applied in a broad range of applications across different industries. Such use cases include, but are not limited to: support coverage (e.g., for technical, IT and software companies with triage/support rotation teams); time-zone coverage (e.g., for customer escalation/support, for critical development teams looking for 24-hour coverage, etc.); domain coverage (e.g., rotations looking for domain or subject matter expert (SME) expertise and representation); limited rollout (e.g., beta/alpha tests on different software and/or hardware product releases, high-impact technology operations (TechOps) upgrades or changes such as developer VM operating system (OS) upgrades); maintenance (e.g., support coverage for released or end-of-life (EOL) products and third-party tool support); non-development (e.g., small group networking, mentoring opportunities, organization-wide roundtables, recurring teaching/volunteer opportunities); etc.

The rotation auto-scheduler tool advantageously takes into account various influencing factors (e.g., through automated feeds) to produce, from a full list of assets (e.g., employees or other users, IT assets, etc.), a filtered list of assets eligible for a given instance or iteration of a rotation schedule. The influencing factors may include constant factors (e.g., geography-specific holidays, agile sprint schedules, etc.) as well as variable factors (e.g., a pool of assets which can be added to or removed over time, an exception list, employee or other user vacations, prior inclusion in one or more instances of the rotation schedule, etc.). The rotation auto-scheduler tool can then perform a random selection from the filtered list of eligible assets for a given instance or iteration of the rotation schedule, taking into account rotation-specific requirements such as the number of required members, skill sets, etc. Such rotation-specific requirements may also be provided or analyzed via automated data feeds, which are customized based on the use case or application area. Examples of rotation-specific requirements include, but are not limited to: a number of assets; skill sets for assets; time zone coverage; site-specific coverage; member team representation; etc. The selection of assets for each instance of a rotation schedule is recorded in a rotation schedule history, which can be used to ensure equitable selection of assets in future instances of the rotation schedule (e.g., to prevent the same assets from serving on multiple consecutive instances of the rotation schedule). The rotation schedule can then be published for stakeholders (e.g., employees or other users, managers of assets selected for the rotation schedule, etc.) to review and request changes, if desired. If changes are requested, then the exception list and rotation history for the requested changes are updated and the rotation auto-scheduler tool repeats the above-described processing until the published rotation schedule is accepted by the stakeholders. Such processing is automated, which is supported by a graphical user interface (GUI) and a scheduling database (DB) manager for maintaining the constant and variable factors as well as pre-scheduled runs of the rotation auto-scheduler tool.

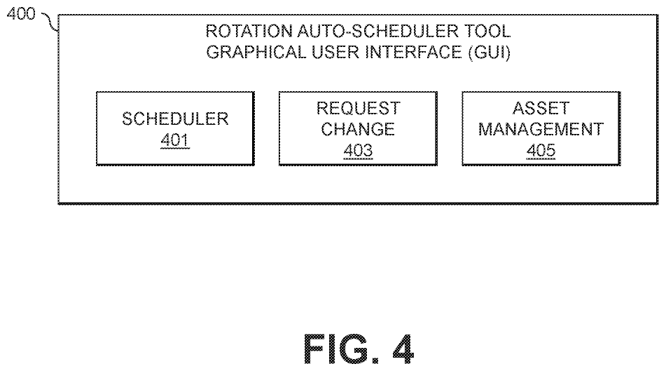

FIG. 4 shows a rotation auto-scheduler tool GUI 400, which includes interface features for launching scheduler functionality 401, change request functionality 403 and asset management functionality 405. The scheduler functionality 401 aids in configurating and generating the next one or more instances of the rotation schedule. The change request functionality 403 allows an end-user to request changes to currently generated rotation schedulers. The asset management functionality 405 allows an end-user to add, remove or change assets which are eligible for selection for one or more instances of a rotation schedule.

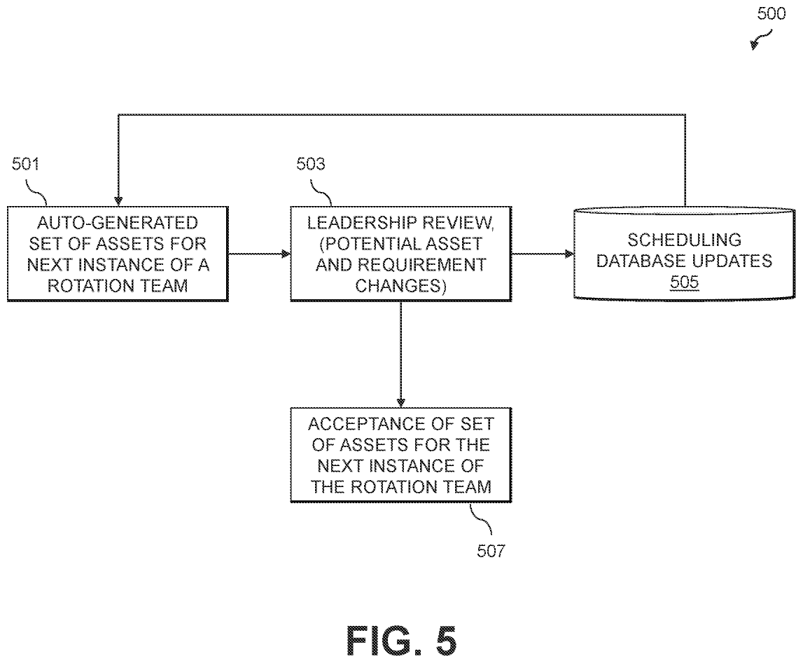

FIG. 5 shows a system flow 500, which may be implemented utilizing a rotation auto-scheduler tool. The rotation auto-scheduler tool may comprise logic in the form of a Python script or another type of program, which is hosted on a server exposed via one or more representational state transfer (REST) application programming interfaces (APIs). A request from a GUI (e.g., the rotation auto-scheduler tool GUI 400) makes its way to the Python script, which interacts with the GUI and an underlying management database to support requested functions in addition to automatically generating assets for a next instance of a rotation schedule. The GUI and management database are configured to support automation for the generation of instances of the rotation schedule via the rotation auto-scheduler tool. As shown in the system flow 500, an auto-generated set of assets for a next instance of a rotation team 501 is provided for leadership review 503 (e.g., which may include initiating one or more potential asset and requirement changes for the rotation team). Such changes from the leadership review 503 are provided for updates to a scheduling database 505. The updated scheduling database 505 is then used to re-generate the set of assets selected for the next instance of the rotation team in 501. If there are no changes requested by the leadership review 503, an acceptance of the set of assets for the next instance of the rotation team 507 is provided.

The rotation auto-scheduler tool provides numerous automation aspects, including automated management of a pool of assets, automated publishing of rotation schedules and secking of stakeholder and/or leadership review, automated management of input data updates into the scheduling database during the rotation schedule generation process, etc. Constant and variable factors used by the rotation scheduler tool can also be made available and are easy to generate and add/modify/delete using the rotation scheduler tool GUI. It should be noted that FIG. 5 shows an example of an auto-generated instance of a rotation schedule that is a team made up of people that are part of the rotation. In other embodiments, the rotation schedule may specify a mix of assets (e.g., physical or virtual computing resources) that are assigned for performing one or more tasks in an instance of the rotation schedule.

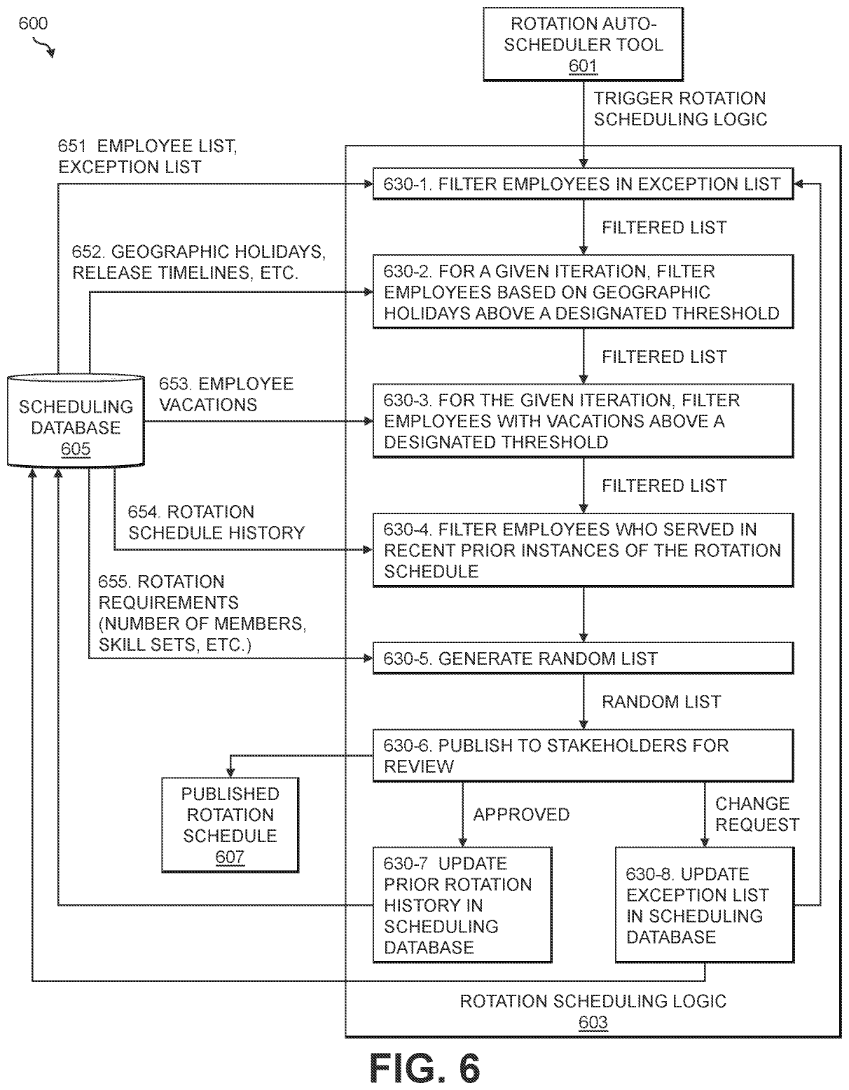

FIG. 6 shows a system flow 600, which includes a rotation auto-scheduler tool 601 which is used to trigger rotation scheduling logic 603 for generating a rotation schedule, which in this example is a central team of employees or other users within an organization. As discussed above and elsewhere herein, however, the rotation schedule may more generally be used for selecting assets which are used for performing one or more desired tasks, and the assets are not limited to employees or other users within an organization. The rotation scheduling logic 603 utilizes various information from a scheduling database 605 in order to produce a published rotation schedule 607. In step 630-1, a feed 651 established between the scheduling database 605 and the rotation scheduling logic 603 (e.g., using REST or another type of API) is used to obtain an employee list and an exception list. Employees in the employee list are then filtered in accordance with the exception list. The employee list includes a list of employees (or, more generally, users) who may be selected for inclusion in different iterations of a rotation schedule. The result of step 630-1 is a filtered list, which is then analyzed in step 630-2.

In step 630-2, a feed 652 established between the scheduling database 605 and the rotation scheduling logic 603 (e.g., using REST or another type of API) is used to obtain information related to geographic holidays, release timelines (e.g., for projects that employees are working on), etc. The rotation scheduling logic 603 utilizes such information in step 630-2 to filter employees in the filtered list received as a result of step 630-1, and produces a further filtered list which is used in subsequent processing in step 630-3. Step 630-2, for example, includes filtering employees based on geographic holidays above a designated threshold (e.g., to remove employees from the filtered list who are located in geographic areas which observe geographic holidays in the time frame of a given instance of the rotation schedule).

In step 630-3, a feed 653 established between the scheduling database 605 and the rotation scheduling logic 603 (e.g., using REST or another type of API) is used to obtain information related to employee vacations. The rotation scheduling logic 603 uses such information to further filter the list of employees eligible for selection for the given instance of the rotation schedule. The result is a further filtered list which is provided to step 630-4 for subsequent processing.

In step 630-4, a feed 654 established between the scheduling database 605 and the rotation scheduling logic 603 (e.g., using REST or another type of API) is used to obtain information related to prior instances of the rotation schedule (e.g., which employees were selected and have served in prior instances of the rotation schedule). The rotation scheduling logic 603 uses such information to filter or remove employees who served in recent prior instances of the rotation schedule from the list of employees eligible for selection in the given instance of the rotation schedule.

In step 630-5, a feed 655 established between the scheduling database 605 and the rotation scheduling logic 603 (e.g., using REST or another type of API) is used to obtain information related to rotation requirements (e.g., a number of members, required skill sets, etc.). The rotation scheduling logic 603 uses such information and the filtered list of employees eligible for selection in the given iteration of the rotation schedule to generate a random list of the eligible employees for the given iteration of the rotation schedule. The generated list is then published to stakeholders (e.g., the selected employees, managers of the selected employees, etc.) for review in step 630-6 as the published rotation schedule 607. If the published rotation schedule 607 is approved by the stakeholders, the rotation schedule logic 603 in step 630-7 updates the prior rotation history in the scheduling database 605. If the stakeholders submit one or more change requests for the published rotation schedule 607, the rotation scheduling logic 603 in step 630-8 updates the exception list in the scheduling database 605 and the processing returns to step 630-1.

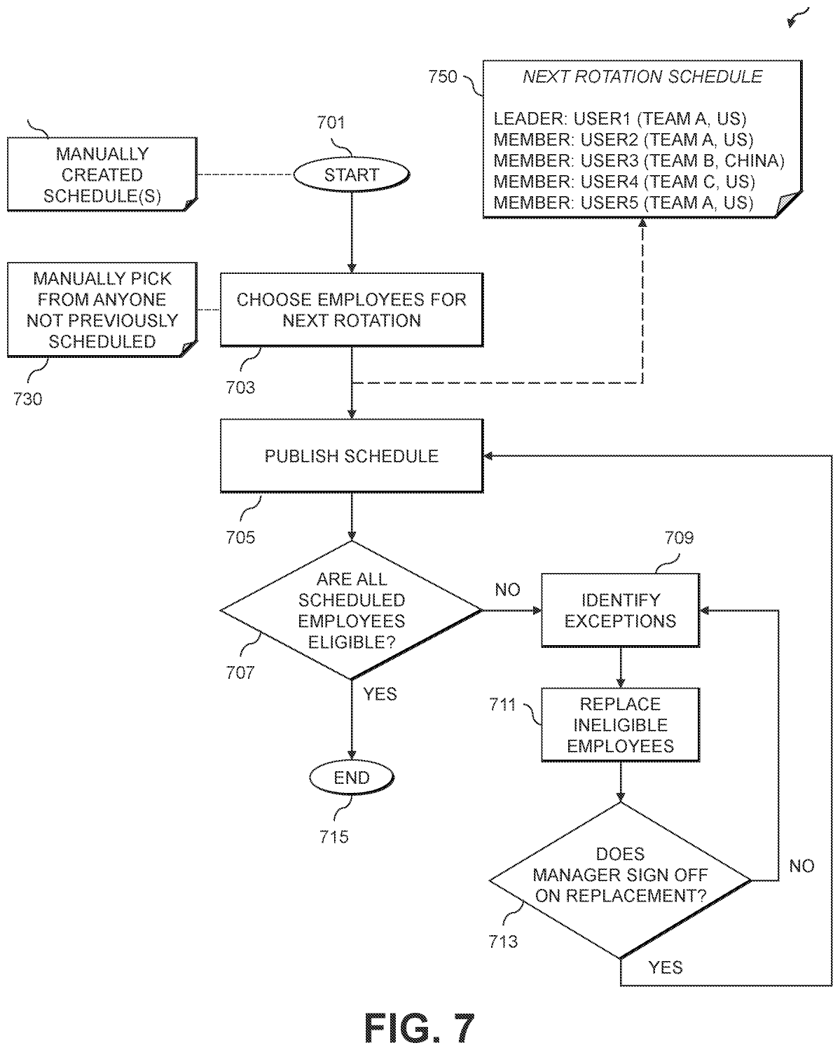

FIG. 7 shows a process flow 700 for creating an instance of the rotation schedule (e.g., for a central team of employees of an organization) without use of a rotation auto-scheduler tool. The process flow 700 starts in step 701, where one or more manually created schedules 710 are input. In step 703, a user manually chooses employees for the next rotation (e.g., by manually picking from anyone not previously scheduled 730). In step 705, the next rotation schedule 750 is published. Here, the next rotation schedule 750 includes one leader and four members, although this is not a requirement (e.g., different numbers of leaders and members may be selected for a given instance of a rotation schedule). In step 707, a determination is made as to whether all employees in the next instance of the rotation schedule 750 are eligible. If the result of the step 707 determination is no, exceptions are identified in step 709. Identifying exceptions in step 709 may include, for example, a manager or employee identifying an exception (e.g., such as one of the selected members in the next instance of the rotation schedule 750 being on vacation, there being too many members selected from a single team such as Team A, there not being enough coverage outside of certain time zones, etc.). Any ineligible employees are replaced in step 711. In step 713, a determination is made as to whether a manager (or other stakeholders) sign off on the replacements made in step 711. If the result of the step 713 determination is no, the process flow 700 returns to step 709. If the result of the step 713 determination is yes, the process flow 700 returns to step 705 where a new schedule is published. Once the result of the step 707 determination is yes, the process flow 700 ends in step 715. It should be noted that the exception flow (e.g., steps 707 through 713) may be performed any number of times until all ineligibilities have been individually identified and resolved, and requires significant time and manual effort. The exception flow is also subject to human error, as it is not practical for a human user to keep track of all the different influencing factors to be considered in generating equitable and effective rotation schedules. As noted above, manual approaches are fraught with issues due to the complexity and impracticality of managing rotation schedules for large organizations.

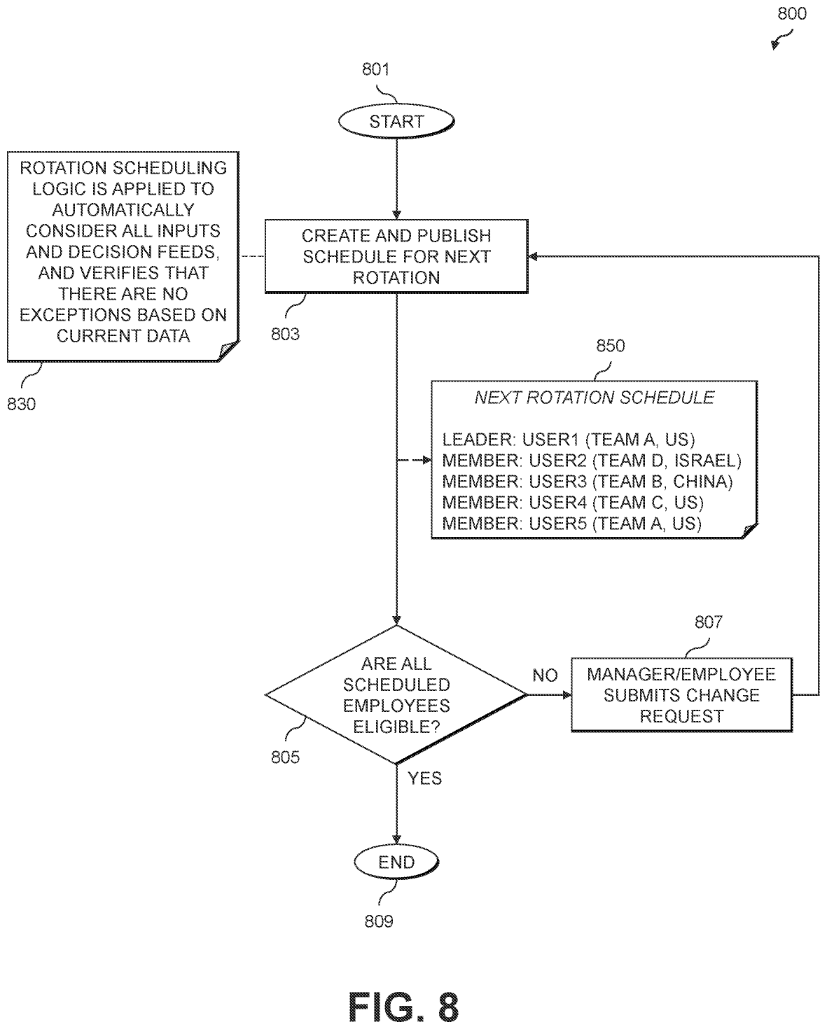

FIG. 8 shows an automated process flow 800 which may be performed using a rotation auto-scheduler tool as described herein for creating an instance of a rotation schedule (e.g., for a central team of employees of an organization). The process flow 800 begins in step 801. In step 803, rotation scheduling logic 830 is applied automatically to consider all inputs and decision feeds and verify that there are no exceptions based on the current data. The schedule for the next instance of the rotation schedule 850 is created and published to key stakeholders. In this example, the rotation schedule 850 includes one leader and four members though this is not a requirement. In step 805, a determination is made as to whether all scheduled employees in the rotation schedule 850 are eligible. If the result of the step 805 determination is no, a manager, employee or other user submits a change request in step 807 and the process flow 800 returns to step 803. This loop may be applied again such that the rotation auto-scheduler tool applies the rotation scheduling logic 830 again to consider all inputs and decision feeds (including the submitted change requests) to verify that there are no exceptions based on the current data. If the result of the step 805 determination is yes, the process flow 800 ends in step 809.

Conventional approaches for creating a rotation schedule require significant time and manual effort for a human schedule maker to consider multiple disparate streams of information (e.g., scrum team information, time zones, holiday schedules, individual vacation information, etc.) and pull together a rotation schedule for X upcoming rotations that will be free of conflicts and equitable for an organization. Such schedules may be stored in a locked file, which does not transparently record updates and changes made to the schedules. Major technical problems with such conventional approaches include that the time-consuming manual process to create the schedule often requires multiple changes due to multiple conflicting and potentially inaccessible pieces of information (e.g., a planned vacation for an individual which is not published in a shared space). Such technical problems also include that one human user cannot practically keep track of every asset's availability, regional holiday and time off schedule, domain expertise, etc., and account for potential changes to such information over time. Further, change requests to swap assets in and out of rotations can be difficult and not transparent (e.g., relying on side-conversations, manual and untracked updates to the schedule, and individual-initiated communication about changes being made, etc.).

The technical solutions described herein provide various technical advantages for creating rotation schedules using a rotation auto-scheduler tool. The rotation auto-scheduler tool advantageously considers constant, variable and other influencing factors simultaneously. Such factors include, but are not limited to: geographic-specific holidays; changing pools of assets; asset vacations or other scheduled offline or unavailable times; domain expertise; release/delivery timelines; distribution of rotation assets across teams ensuring various requirements are met (e.g., no more than X assets from a same team, time zone based distribution of assets for around-the-clock coverage, etc.); and rotation-specific requirements where some rotations may need more or less assets, assets with different domain expertise, etc.

The rotation auto-scheduler tool may be integrated with various other tools to provide a reliable single source of truth model. For example, information available in such other tools may be used to provide further customization and improvements to the rotation schedules. For example, issue tracking products (e.g., Jira) may be used to obtain information related to official sprint/potentially shippable increment (PSI) dates, an up-to-date list of assets, individual availability/capacity, etc. Issue tracking products may also be used to obtain information related to previous rotation defect triage data (e.g., data analysis that could impact rotation needs such as number of members, domain expertise needed, etc.). Collaboration tools (e.g., Confluence) may be used to provide a widely accessible way to view rotation schedule information.

The rotation auto-scheduler tool also advantageously provides for easy and transparent interventions for rotation schedule change requests once rotation schedules are created. Consider, for example, change request situations including when an asset or individual has planned time off, when the rotation auto-scheduler tool determines that critical work requires a scheduled asset. when assets join/leave an organization, etc. The rotation auto-scheduler tool further provides functionality for dealing with changes in rotation requirements (e.g., fluctuating numbers of assets on a rotation based on varying needs). Consider, for example, increases in the number of assets selected for a rotation right after a product release, decreases in the number of assets selected for a rotation based on historical data showing low bug counts or other issues that need to be resolved by the rotation team, etc.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for automated generation of rotation schedules will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100 in FIG. 1. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or one or more other types of operating systems.

The cloud infrastructure 900 further comprises sets of applications 910-1, 910-2, . . . 910-L running on respective ones of the VMs/container sets 902-1, 902-2 . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. A hypervisor platform may be used to implement a hypervisor within the virtualization infrastructure 904, where the hypervisor platform has an associated virtual infrastructure management system. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of the information processing system 100 and includes a plurality of processing devices, denoted 1002-1, 1002-2, 1002-3 . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012.

The processor 1010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1012 may comprise random access memory (RAM), read-only memory (ROM), flash memory or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in FIG. 10 is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for automated generation of rotation schedules as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, information technology assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to receive a request to generate a given instance of a rotation schedule;
to establish one or more data feeds, each of the one or more data feeds comprising information affecting eligibility of a plurality of assets for inclusion in the given instance of the rotation schedule;
to generate one or more data structures by parsing information from the one or more data feeds, the one or more data structures comprising a filtered subset of the plurality of assets which are eligible to be selected for inclusion in the given instance of the rotation schedule; and
to generate the given instance of the rotation schedule by selecting, from among the filtered subset of the plurality of assets which are eligible to be selected for inclusion in the given instance of the rotation schedule, one or more of the plurality of assets for the given instance of the rotation schedule, wherein selecting the one or more of the plurality of assets for the given instance of the rotation schedule is based at least in part on information from at least one of the one or more data feeds characterizing requirements related to composition of the given instance of the rotation schedule.

2. The apparatus of claim 1 wherein the one or more data feeds comprise one or more representational state transfer (REST) or other application programming interfaces (APIs).

3. The apparatus of claim 2 wherein at least one of the one or more REST APIs is established with a scheduling database maintained by an organization managing the plurality of assets.

4. The apparatus of claim 1 wherein the plurality of assets comprise information technology assets of an information technology infrastructure.

5. The apparatus of claim 1 wherein the rotation schedule specifies a given team of an organization that is responsible for management of one or more information technology assets of the organization.

6. The apparatus of claim 1 wherein generating the one or more data structures comprises:
generating a first data structure by parsing first information from a first one of the one or more data feeds, the first information characterizing ones of the plurality of assets which may be selected for inclusion in the given instance of the rotation schedule;
generating a second data structure by filtering the first data structure using second information parsed from a second one of the one or more data feeds, the second information characterizing scheduling conflicts for the ones of the plurality of assets which may be selected for inclusion in the given instance of the rotation schedule;
generating a third data structure by filtering the second data structure using third information parsed from a third one of the one or more data feeds, the third information characterizing ones of the plurality of assets selected for inclusion in one or more previous instances of the rotation schedule; and
generating a fourth data structure by selecting, using fourth information parsed from a fourth one of the one or more data feeds, the filtered subset of the plurality of assets which are eligible for inclusion in the given instance of the rotation schedule, the fourth information comprising one or more organization requirements related to the composition of the given instance of the rotation schedule.

7. The apparatus of claim 6 wherein generating the first data structure comprises creating a list of the plurality of assets meeting one or more eligibility criteria.

8. The apparatus of claim 6 wherein generating the second data structure comprises utilizing the second information to at least one of:
remove ones of the plurality of assets located in geographic regions having geographic holidays observed during a time frame of the given instance of the rotation schedule; and
remove ones of the plurality of assets based at least in part on deadlines for one or more tasks that the plurality of assets are responsible for.

9. The apparatus of claim 6 wherein generating the third data structure comprises utilizing the third information to remove ones of the plurality of assets which have been selected for inclusion in the one or more previous instances of the rotation schedule.

10. The apparatus of claim 1 wherein the requirements related to the composition of the assets in the given instance of the rotation schedule comprise one or more requirements related to at least one of:
a number of the plurality of assets to be selected for inclusion in the given instance of the rotation schedule; and
geographic locations of ones of the plurality of assets to be selected for inclusion in the given instance of the rotation schedule.

11. The apparatus of claim 1 wherein the requirements related to the composition of the assets in the given instance of the rotation schedule comprise one or more requirements related to functionalities of ones of the plurality of assets to be selected for inclusion in the given instance of the rotation schedule.

12. The apparatus of claim 1 wherein the at least one processing device is further configured:
to publish the given instance of the rotation schedule; and
to determine whether the given instance of the rotation schedule is accepted by one or more authorized users.

13. The apparatus of claim 12 wherein, responsive to the one or more authorized users accepting the given instance of the rotation schedule, updating information in at least one of the one or more data feeds characterizing ones of the plurality of assets which have been selected for inclusion in one or more previous instances of the rotation schedule.

14. The apparatus of claim 12 wherein, responsive to the one or more authorized users submitting one or more change requests for the given instance of the rotation schedule:
modifying information in at least one of the one or more data feeds characterizing at least one of ones of the plurality of assets which may be selected for inclusion in the given instance of the rotation schedule and scheduling conflicts for the ones of the plurality of assets which may be selected for inclusion in the given instance of the rotation schedule; and
re-generating the given instance of the rotation schedule based at least in part on the modified information in said at least one of the one or more data feeds.

15. A computer program product comprising a non-transitory processor-readable storage medium having stored therein program code of one or more software programs, wherein the program code when executed by at least one processing device causes the at least one processing device:
to receive a request to generate a given instance of a rotation schedule;
to establish one or more data feeds, each of the one or more data feeds comprising information affecting eligibility of a plurality of assets for inclusion in the given instance of the rotation schedule;
to generate one or more data structures by parsing information from the one or more data feeds, the one or more data structures comprising a filtered subset of the plurality of assets which are eligible to be selected for inclusion in the given instance of the rotation schedule; and
to generate the given instance of the rotation schedule by selecting, from among the filtered subset of the plurality of assets which are eligible to be selected for inclusion in the given instance of the rotation schedule, one or more of the plurality of assets for the given instance of the rotation schedule, wherein selecting the one or more of the plurality of assets for the given instance of the rotation schedule is based at least in part on information from at least one of the one or more data feeds characterizing requirements related to composition of the given instance of the rotation schedule.

16. The computer program product of claim 15 wherein the one or more data feeds comprise one or more representational state transfer (REST) application programming interfaces (APIs), and wherein at least one of the one or more REST APIs is established with a scheduling database maintained by an organization managing the plurality of assets.

17. The computer program product of claim 15 wherein generating the one or more data structures comprises:
generating a first data structure by parsing first information from a first one of the one or more data feeds, the first information characterizing ones of the plurality of assets which may be selected for inclusion in the given instance of the rotation schedule;
generating a second data structure by filtering the first data structure using second information parsed from a second one of the one or more data feeds, the second information characterizing scheduling conflicts for the ones of the plurality of assets which may be selected for inclusion in the given instance of the rotation schedule;
generating a third data structure by filtering the second data structure using third information parsed from a third one of the one or more data feeds, the third information characterizing ones of the plurality of assets selected for inclusion in one or more previous instances of the rotation schedule; and
generating a fourth data structure by selecting, using fourth information parsed from a fourth one of the one or more data feeds, the filtered subset of the plurality of assets which are eligible for inclusion in the given instance of the rotation schedule, the fourth information comprising one or more organization requirements related to the composition of the given instance of the rotation schedule.

18. A method comprising:
receiving a request to generate a given instance of a rotation schedule;
establishing one or more data feeds, each of the one or more data feeds comprising information affecting eligibility of a plurality of assets for inclusion in the given instance of the rotation schedule;
generating one or more data structures by parsing information from the one or more data feeds, the one or more data structures comprising a filtered subset of the plurality of assets which are eligible to be selected for inclusion in the given instance of the rotation schedule; and
generating the given instance of the rotation schedule by selecting, from among the filtered subset of the plurality of assets which are eligible to be selected for inclusion in the given instance of the rotation schedule, one or more of the plurality of assets for the given instance of the rotation schedule, wherein selecting the one or more of the plurality of assets for the given instance of the rotation schedule is based at least in part on information from at least one of the one or more data feeds characterizing requirements related to composition of the given instance of the rotation schedule;
wherein the method is performed by at least one processing device comprising a processor coupled to a memory.

19. The method of claim 18 wherein the one or more data feeds comprise one or more representational state transfer (REST) application programming interfaces (APIs), and wherein at least one of the one or more REST APIs is established with a scheduling database maintained by an organization managing the plurality of assets.

20. The method of claim 18 wherein generating the one or more data structures comprises:
generating a first data structure by parsing first information from a first one of the one or more data feeds, the first information characterizing ones of the plurality of assets which may be selected for inclusion in the given instance of the rotation schedule;
generating a second data structure by filtering the first data structure using second information parsed from a second one of the one or more data feeds, the second information characterizing scheduling conflicts for the ones of the plurality of assets which may be selected for inclusion in the given instance of the rotation schedule;
generating a third data structure by filtering the second data structure using third information parsed from a third one of the one or more data feeds, the third information characterizing ones of the plurality of assets selected for inclusion in one or more previous instances of the rotation schedule; and
generating a fourth data structure by selecting, using fourth information parsed from a fourth one of the one or more data feeds, the filtered subset of the plurality of assets which are eligible for inclusion in the given instance of the rotation schedule, the fourth information comprising one or more organization requirements related to the composition of the given instance of the rotation schedule.
